(19) United States
(12) Patent Application Publication
(10) Pub. No.: US 2011/0169182 A1
(43) Pub. Date: Jul. 14, 2011

(54) METHODS OF FORMING BULK ABSORBERS

(75) Inventors: James Piascik, Randolph, NJ (US); Reza Oboodi, Morris Plains, NJ (US); James F. Stevenson, Morristown, NJ (US); Martin Carlin Baker, Budd Lake, NJ (US); Siu-Ching D. Lui, Warren, NJ (US)

(73) Assignee: HONEYWELL INTERNATIONAL INC., Morristown, NJ (US)

(21) Appl. No.: 12/256,939

(22) Filed: Oct. 23, 2008

(51) Int. Cl. B29C 44/12; B29C 35/02

(52) U.S. Cl. 264/45.3; 264/641

(57) ABSTRACT

The inventive subject matter provides methods of manufacturing bulk absorbers and noise suppression panels. In one embodiment, and by way of example only, a method of manufacturing bulk absorbers includes mixing a first type of fibers and a binder together to form a material mixture, the first type of fibers comprising ceramic microfibers, and the binder comprising a glass material, hydrating the material mixture with water vapor to form a hydrated mixture, and heat treating the hydrated mixture to form the bulk absorber

### TECHNICAL FIELD

The inventive subject matter relates to aircraft and, more particularly, to bulk absorbers for use in aircraft.

### BACKGROUND

Many aircraft are powered by jet engines. In most instances, jet engines include one or more gas-powered turbine engines, auxiliary power units (APUs), and/or environmental control systems (ECSs), which can generate both thrust to propel the aircraft and electrical and pneumatic energy to power systems installed in the aircraft. Although aircraft engines are generally safe, reliable, and efficient, the engines do exhibit certain drawbacks. For example, turbine engines can be sources of noise, especially during aircraft take-off and landing operations. Additionally, APUs and ECSs can be sources of ramp noise while an aircraft is parked at the airport. Thus, various governmental and aircraft manufacturer rules and regulations aimed at mitigating such noise sources have been enacted.

To address the noise emanating from aircraft noise sources and to thereby comply with the above-mentioned rules and regulations, various types of noise reduction systems have been developed. For example, noise suppression panels have been incorporated into some aircraft ducts and plenums. Typically, noise suppression panels have flat or contoured outer surfaces, and include either a bulk absorber material or a honeycomb structure disposed between a backing plate and a face plate. The noise suppression panels are placed on an interior surface of an engine or in an APU inlet and/or outlet ducts, as necessary, to reduce noise emanations.

Although the above-described noise suppression panels exhibit fairly good noise suppression characteristics, they may be improved. In particular, the bulk absorber materials incorporated into noise suppression panels can be costly to manufacture. In some cases, the bulk absorber materials may not be suitable for incorporation into an exhaust section of the engine. Additionally, honeycomb structures that may be used in the noise suppression panels may be difficult to conform to contoured surfaces and can be difficult to bond to the backing plate and/or face plate. Moreover, when the honeycomb structure is combined with an inexpensive perforate face plate, the honeycomb structure may provide noise attenuation over only a relatively narrow frequency range.

Hence, there is a need for a noise suppression panel that is less costly to manufacture than conventional noise suppression panels. Additionally, it is desirable for the noise suppression panel to be effective over a relatively wide temperature and/or frequency ranges. Further, it is desirable for the noise suppression panel to have continued effectiveness even when used over a wide temperature range and when exposed to fluids, such as fuel and/or water.

### BRIEF SUMMARY

The inventive subject matter provides methods of manufacturing bulk absorbers and noise suppression panels.

In one embodiment, and by way of example only, a method of manufacturing bulk absorbers includes mixing a first type of fibers and a binder together to form a material mixture, the first type of fibers comprising ceramic microfibers, and the binder comprising a glass material, hydrating the material mixture with water vapor to form a hydrated mixture, and heat treating the hydrated mixture to form the bulk absorber.

In another embodiment, and by way of example only, a method of manufacturing bulk absorbers includes mixing a first type of microfiber and a binder together to form a material mixture, the first type of microfiber comprising a mineral-based material, and the binder comprising glass fibers and linking microfibers of the first type of microfiber to fibers of the glass fibers by heat treating the material mixture at a predetermined temperature for softening the glass fibers to thereby form the bulk absorber.

In still another embodiment, and by way of example only, a method of manufacturing noise suppression panels includes mixing a first type of fibers and a binder together to form a material mixture, the first type of fibers comprising a ceramic material, and the binder comprising a water-soluble glass powder, hydrating the material mixture with water droplets to form a hydrated mixture, heat treating the hydrated mixture to form a bulk absorber; and placing the bulk absorber between a face plate and a backing plate to form the noise suppression panel.

Other independent features and advantages of the preferred material and methods will become apparent from the following detailed description, taken in conjunction with the accompanying drawings which illustrate, by way of example, the principles of the inventive subject matter.

### BRIEF DESCRIPTION OF THE DRAWINGS

FIG. 1 is a perspective, cutaway view of a noise suppression panel, according to an embodiment;

FIG. 2 is a method for manufacturing a material that may be used as a bulk absorber in a noise suppression panel, according to an embodiment;

FIG. 3 is a micrograph of a portion of a bulk absorber material manufactured according to an embodiment of the method of FIG. 2; and

FIGS. 4-6 are micrographs of a portion of the bulk absorber manufacture according to another embodiment of the method of FIG. 2.

### DETAILED DESCRIPTION

Before proceeding with the detailed description, it is to be appreciated that the described embodiment is not limited to use in conjunction with a particular type of engine, or in a particular type of vehicle. Thus, although the present embodiment is, for convenience of explanation, described as being implemented in an aircraft environment, it will be appreciated that it can be implemented in various other types of vehicles, and in various other systems and environments. Moreover, although the inventive subject matter is described as being implemented into a noise suppression panel, the inventive subject matter may be used alone or in combination with other structures to reduce noise.

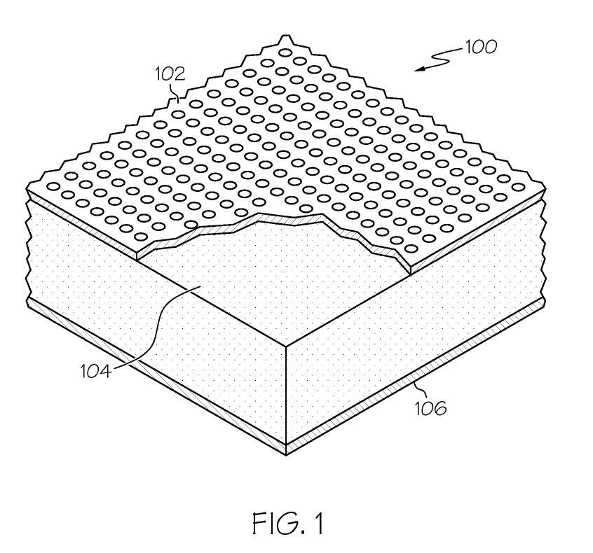

FIG. 1 is a perspective, cutaway view of a noise suppression panel 100, according to an embodiment. The noise suppression panel 100 is adapted to reduce an amount of noise that may travel from one area to another. According to an embodiment, the noise suppression panel 100 may be disposed in an aircraft to reduce noise that may emanate from an engine. For example, the noise suppression panel 100 may be placed in an aircraft air duct, such as an air inlet plenum or an engine exhaust duct. Although the noise suppression panel 100 is shown as having a generally square shape, it may have any other shape suitable for placement into a designated area of the aircraft.

To suppress noise, the noise suppression panel 100 includes a face plate 102, a bulk absorber 104, and a backing plate 106, in an embodiment. The face plate 102 is configured to receive noise from a noise source, such as the engine, and to allow at least a portion of the noise to pass through. The face plate 102 may be further adapted to provide structure to the noise suppression panel 100. In this regard, the face plate 102 may be constructed of a rigid material conventionally used for providing structure, such as stainless steel, bismaleimide (BMI) carbon fiber composites, and the like.

In an embodiment, to provide acoustic transparency, the face plate 102 is perforated to a desired percent open area value. As is used herein, the phrase “percent open area” (POA) may be defined as an amount of open area that allows passage of sound. In accordance with an embodiment, the face plate 102 is perforated to a POA of greater than 30%. For example, the POA may be in a range of from about 30% to about 50%, although the POA may be more or less. In other embodiments, the POA may be less than 30%.

Although the face plate 102 is shown as comprising a single layer of material, more than one layer of material may make up the face plate 102 in other embodiments. In any case, in accordance with an embodiment, the face plate 102 may have a total thickness in a range of from about 0.2 millimeters (mm) to about 0.8 mm. In other embodiments, the face plate 102 may be thicker or thinner than the aforementioned range.

The bulk absorber 104 is disposed between the face plate 102 and the backing plate 106 and is adapted to attenuate a majority of the noise passing through the face plate 102. In an embodiment, the bulk absorber 104 includes microfibers and a binder. The microfibers may comprise one or more types of fiber materials. Suitable fiber materials include organic fibers, such as carbon-based microfibers including, but not limited to polyacrylonitrile (PAN)-based carbon fibers sold under the trade name Thornel® T-300 PAN available through Cytec Industries, Inc. of West Paterson, N.J. In another embodiment, the fiber materials may include glass fibers, such as silicate fibers including, but not limited to E-glass fibers. For example, the glass fibers may comprise a high silica fiber felt such as Silcosoft® available through BGF Industries, Inc. of Greensboro, N.C. In still another embodiment, the fiber materials may include mineral-based fibers, such as basalt microfibers, such as Sudaglass® available through Sudaglass Fiber Technology, Inc. of Houston, Tex. In still another embodiment, polymer fiber materials may be included. In an embodiment, the polymer fiber materials include aramid microfibers such as fibrillated poly (aromatic amide) microfibers available from E.I. DuPont de Nemours of Delaware under the tradename Kevlar® pulp, acrylic pulp or other similar materials. In other embodiments, the lengths may be greater than or less than the aforementioned range. In one embodiment, the fiber materials include a microfiber material mixture comprising silica fibers and basalt fibers. In another embodiment, the fiber materials include a microfiber material mixture comprising carbon fibers and basalt fibers. In still another embodiment, the fiber materials include a microfiber material mixture comprising carbon fibers and aramid fibers. In still another embodiment, the fiber materials only include silica fibers. Other embodiments may include other fiber materials. In any case, the microfibers may be relatively “long” and may have lengths in a range of from about 10 millimeters (mm) to about 100 mm, in an embodiment.

The fiber materials may be included as reinforcement microfibers and/or fibrillated microfibers. As used herein, the phrase “reinforcement microfibers” may be defined as microfibers having a relatively straight configuration and a stiff, high modulus (e.g., a modulus of greater than 200 GPa) and that when bonded to each other with a binder, give the material mechanical integrity and/or resistance to deformation. The phrase “fibrillated microfibers”, as used herein, may be defined as fibers having branched or splintered configurations. In an embodiment, the fiber materials include both reinforcement microfibers and fibrillated microfibers to comprise a random network to form a microfiber material mixture having a plurality of openings. The plurality of openings allows the bulk absorber 104 to have a physical configuration that resembles a fluffy mass and to have a particular volume fraction of solids suitable for absorbing the sound passing through the face plate 102 in the bulk absorber 104. The “volume fraction of solids” may be defined as a percentage of a volume that is occupied by a solid material. In an embodiment in which the microfibers represent the solid material, the bulk absorber 104 may have a volume fraction of solids in a range of from about 1.5% to about 5.5%. In another embodiment, the volume fraction of solids may more preferably in the range of about 3% to about 4%. In still other embodiments, the volume fraction of solids may be greater than or less than the aforementioned ranges.

To maintain the desired physical configuration of the fiber materials, a binder is included that is capable of providing mechanical integrity to the fiber materials without substantially degrading the noise attenuation capabilities of the fiber materials or adding to the weight of the structure. Suitable binders include various types of glass (e.g., silicates). In an embodiment, the glass may include a water-soluble form of glass, such as sodium metasilicate. In such case, the glass may be dispersed throughout the fiber materials as a glass powder binder at a ratio to the microfibers in a range of from about 0.20:1 to about 1:1 ratio, by weight. In accordance with an embodiment, the bulk absorber 104 may include between about 50% to about 80% by weight of the microfibers and between about 50% to about 20% by weight of the glass powder binder. In other embodiments, the ratios may be greater or less.

According to another embodiment, the glass binder may comprise glass fibers having lengths that are shorter than the lengths of the fiber materials mentioned above. For example, the glass fibers may have lengths in a range of from about 5 mm to about 25 mm. In one embodiment in which the fiber materials do not include glass fibers as a type of microfiber, the glass fibers selected for the binder has a melting temperature that is less than a melting temperature of the fiber materials. In another embodiment in which the fiber materials include silica fibers as a type of microfiber, the glass fibers selected for the binder may have a melting temperature that is substantially equal to (e.g. within ±5° C.) or that is less than the melting temperature of the silica fibers used for the fiber material. In this way, in such an embodiment, portions of the fiber may be fused onto other glass fibers or other fibers of the microfibers. The locations may form junctions in the shape of spheres, in an embodiment. Additionally or alternatively, the locations may link two or more microfibers together, two or more glass fibers and microfibers together and/or two or more glass fibers together. According to an embodiment, the glass fiber binder and the microfibers may be present at a ratio in a range of from about 0.2:1 to about 1:1 ratio, by weight. In accordance with an embodiment, the bulk absorber 104 may include between about 50% to about 80% by weight of the microfibers and between about 50% to about 20% by weight of the glass fiber binder. In other embodiments, the ratios may be greater or less.

The backing plate 106 is adapted to provide structure to the noise suppression panel 100 and is preferably imperforate and constructed from a non-porous material. In an embodiment, the backing plate 106 may include stainless steel. In another embodiment, the backing plate 106 may be constructed of bismaleimide (BMI). In still other embodiments, the backing plate 106 may include other materials capable of providing structure. Additionally, although the backing plate 106 is shown as comprising a single layer of material, in other embodiments, more than one layer of material may make up the backing plate 106. In any case, in accordance with an embodiment, the backing plate 106 may have a total thickness in a range of from about 0.5 mm to about 4.0 mm. In other embodiments, the backing plate 106 may be thicker or thinner than the aforementioned range.

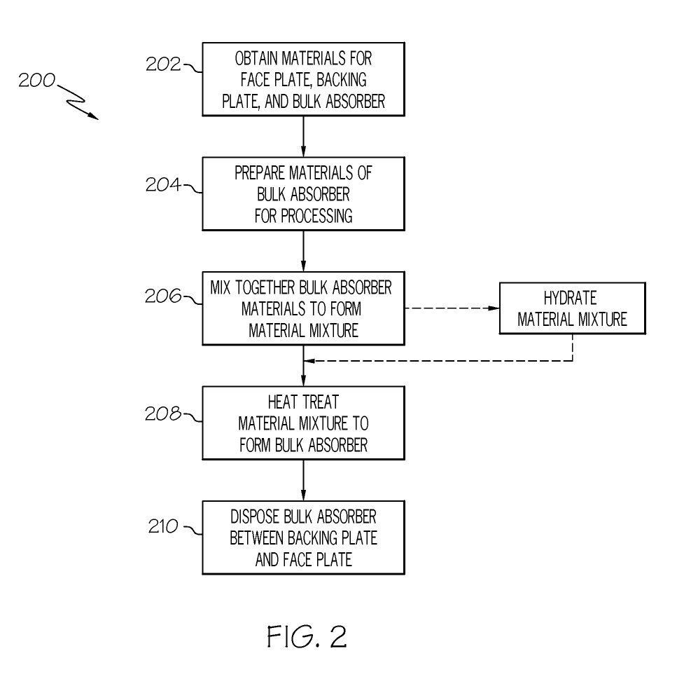

To manufacture the noise suppression panel 100, method 200, an embodiment of which is illustrated in a flow diagram in FIG. 2, may be employed. According to an embodiment, materials suitable for use as a face plate, a backing plate, and a bulk absorber are obtained, step 202. The materials may be selected from any of the materials mentioned above in the description of the face plate 102, backing plate 106, and the bulk absorber 104. For example, as noted above, the bulk absorber may be formulated to include microfibers and a binder, and these materials may be selected from the materials mentioned above for bulk absorber 104. In an embodiment, the microfibers may include a material mixture comprising silica fibers and basalt fibers. In another embodiment, the microfibers include a material mixture comprising carbon fibers and aramid fibers. In still another embodiment, the microfibers only include silica fibers. Other embodiments may include other fiber materials such as alumina fiber. In an embodiment, the binder may include glass (silica) fibers, such as E glass fibers.

In an embodiment, one or more of the materials to be included in the bulk absorber (e.g., the microfibers (e.g., fibrillated and/or reinforcement microfibers) and the binder) are prepared for processing, step 204. In one example, the fibrillated microfibers and/or the reinforcement microfibers are cut to desired lengths. In an embodiment, the desired lengths may be in a range of from about 2 cm to about 8 cm. In other embodiments, the microfibers may be cut to lengths that are greater than or less than the aforementioned range. In some embodiments, only a portion of the microfibers (e.g., some of the fibrillated microfibers and/or some of the reinforcement microfibers) may be cut to the desired lengths, while another portion of the microfibers may not be cut. In another example embodiment, the binder is formed into a powder having particles sizes in a range of from about 3 microns to about 100 microns. In this way, the powder may be more likely to coat the microfibers, rather than settle out of the fiber material during manufacture. For example, the binder may be ball-milled, pulverized or ground. According to an embodiment in which water-soluble glass is employed, the water-soluble glass may be ground into a powder. In another embodiment in which the binder is glass fiber, the glass fiber may be cut to relatively “short” lengths and may be cut to lengths in a range of from about 5 mm to about 25 mm.

Next, the materials to be included in the bulk absorber are mixed together to form a material mixture, step 206. In an embodiment, the microfibers and the binder are disposed in a mixing device. The mixing device may be any one of numerous devices that includes a container and a rotating blade in the container that contacts and mixes the microfibers and binder. For example, the mixing device may be a blender, and the blade may or may not have a sharp edge capable of cutting the fibers into shorter lengths. In another example, the mixing device may be a commercial blender, which is configured to circulate the materials by rotating the container in addition to mixing the materials with a blade. Suitable commercial blenders include Waring® commercial blenders available through Waring Products, Inc. of Calhoun, Ga. According to an embodiment, an anti-static material may be applied to the surfaces of the container and/or or the mixing device blade and/or other mixing device component prior to mixing so that the materials are prevented from sticking to the container, the blade, and/or other mixing device components. The same result could be achieved with an automated process using air lay technology.

In an embodiment while the microfibers and the binder are mixed, air is incorporated into the material mixture. In accordance with an embodiment, the air is supplied through a tube connected to an air source and is flowed into the container of the mixing device. In another embodiment, the air in the container of the mixing device is incorporated into the microfibers and binders, while the materials are mixing. For example, the materials are circulated within the container of the mixing device and thus, are continuously exposed to the air and blades. In this way, the materials form a loose, fluffy mass. To increase an amount of air that is incorporated into the mass, the mixing device may be pulsed (e.g., turned on and off) to redistribute fibers in the container. In an embodiment, the air is supplied to the material mixture to include a volume fraction of solids in a range of from about 0.5% to about 15.0% therein.

According to an embodiment, the material mixture may be treated to prepare the binder for heat treatment, step 208. In an example embodiment in which the binder includes the glass powder binder, the material mixture is transferred to a humidity chamber and hydrated with water vapor to form a hydrated mixture. In an embodiment, the humidity chamber may have a temperature in a range of from about 30° C. to about 100° C. (Celsius). In other embodiments, the temperature within the humidity chamber may be less than or more than the aforementioned temperature range. However, the material mixture may be exposed longer to the humidity chamber at lower temperatures, while the material mixture may be exposed to the humidity chamber for a shorter duration at high temperatures. In accordance with an embodiment, a ratio of a partial pressure of water vapor in the humidity chamber to a saturated vapor pressure of water vapor within the temperature range may be in a range of from about 70 to about 100%, preferably in a range of from about 85% to about 95%. The material mixture is hydrated to include about 5% to about 95% water, by weight, preferably about 53%, by weight. In any case, the material mixture is exposed to a sufficient amount of water vapor to cause the binder to be wetted. In another embodiment, the material mixture may be exposed to pressurized steam. In still another embodiment, the material mixture may be exposed to water droplets, such as provided by a fine mist of fog.

The material mixture is placed in a mold and heat treated to form the bulk absorber, step 210. In one embodiment, the mold includes a top plate and a bottom plate, each having inner surfaces that define a cavity within which the material mixture is placed. The inner surfaces may define a shape of an outer surface of a resulting bulk absorber. According to an embodiment, the mold may be placed in an oven and subjected to temperatures in a desired temperature range. The desired temperature range may be selected based on whether the binder incorporated into the material mixture is a glass powder or a glass fiber. In an embodiment in which glass powder binder is used, the desired temperature range may be from about 230° C. to about 300° C. In a preferred embodiment, the hydrated mixture is exposed to a temperature of about 230° C. Heat treatment may occur for a period of time ranging from about 30 minutes to about 40 minutes. In other embodiments, the hydrated mixture may be subjected to higher or lower temperatures for a longer or shorter time period. In an embodiment in which glass fiber binder is used, the desired temperature range may include a temperature that is sufficient to cause the glass fiber binder to soften but not to melt. For example, the desired temperature range may include temperatures that are between a softening point temperature of the glass fiber binder and 100° below the softening point temperature of the glass fiber binder. In another example, the desired temperature range may include temperatures that are between the softening point temperature of the glass fiber binder and 60° below the softening point temperature of the glass fiber binder. In an alternate embodiment, the desired temperature range may include temperatures that are between the softening point temperature of the glass fiber binder and 30° below the softening point temperature of the glass fiber binder. The term “softening point temperature”, as used herein, may be defined as a temperature for which a viscosity of glass is 10^{7.65} Poises. For example, E-glass fiber may have a softening point of about 830-860° C., and the desired temperature may be about 800° C.

In an embodiment of the method 200, the bulk absorber is disposed between the face plate and the backing plate, step 212. For example, the bulk absorber may be attached to the backing plate. In an embodiment, the bulk absorber may be adhered to the backing plate with an adhesive capable of withstanding temperatures of at least 648° C. and resisting degradation when exposed to fluids, such as fuel, water and hydraulic fluids. Suitable adhesives include, but are not limited to cements, and the like. The adhesive may be applied to either or both the bulk absorber or to the backing plate, and the bulk absorber and the backing plate may then be brought into contact with each other. In another embodiment, the bulk absorber may be fastened to the backing plate with one or more fasteners. In accordance with an embodiment, the fasteners may include one or more screws, bolts, clamps, or other fastening mechanism. Next, the face plate may be placed over the bulk absorber so that the bulk absorber is disposed between the face plate and the backing plate. Alternatively, the bulk absorber may not be attached to the backing plate, and the bulk absorber may be placed between the face plate and the backing plate without fasteners.

The following examples demonstrate various embodiments of the bulk absorber and the methods of manufacturing the bulk absorber. These examples should not be construed as in any way limiting the scope of the inventive subject matter.

### Example 1

Sodium metasilicate powder (available through Sigma-Aldrich Co. of St. Louis, Mo.) was ball milled to reduce particle size of the powder. Equal masses of the sodium metasilicate powder and a high silica fiber felt (i.e., Silcosoft® from BGF Industries, Inc. of Greensboro, N.C.) were blended for about 15 seconds in a Waring® blender at low speed to form a mixture. Equal weights of the mixture and basalt fibers were mixed for about 10 seconds in the Waring® Blender. The mixture was then packed in a ceramic container to give a structure with density of about 0.0252 g/cc. The ceramic container was then placed in a humidity chamber for 17 hours at 90% RH and 90° C. to saturate the sodium metasilicate powder with water. The contents of the ceramic container were then dried at 110° C. for about one hour, 150° C. for about 2 hours, 230° C. for about 2 hours and then fired at 700° C. for about one hour.

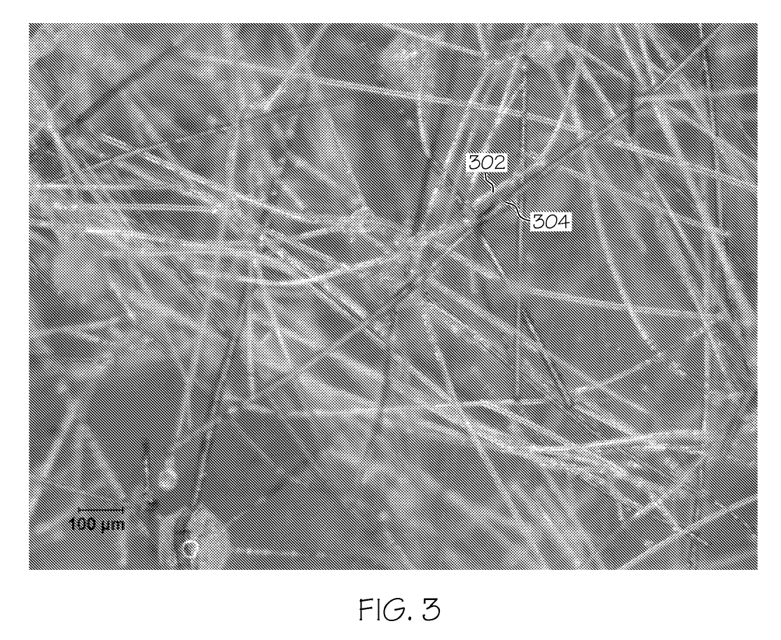

FIG. 3 is a micrograph of a portion of the bulk absorber manufactured according to the above-described process. The bulk absorber includes junctions 310 formed between fibers of the high silica fiber felt 302 and the basalt fibers 304 by the cured sodium metasilicate. In some embodiments, the sodium metasilicate binder tended to coat certain regions of the high silica fiber felt 302 and the basalt fibers.

### Example 2

Equal masses of a first batch of high silica fiber felt (i.e., Silcosoft® from BGF Industries, Inc. of Greensboro, N.C.) and basalt fibers mixed for about 5 seconds in a Waring® Blender to form a mixture. Short glass fiber was added to the above fiber mixture such that the short glass fiber is 20% of the total weight. The mixture was mixed for about 5 seconds in the Waring® Blender. The mixture was then packed in ceramic containers to give a structure with density of about 0.0252 g/cc. One of the ceramic containers was then subjected to a heat treatment at 800° C. for about 0.5 hour. A second ceramic container was subjected to a heat treatment at 900° C. for about 0.5 hour. A third ceramic container was subjected to a heat treatment at 1000° C. for about 0.5 hour.

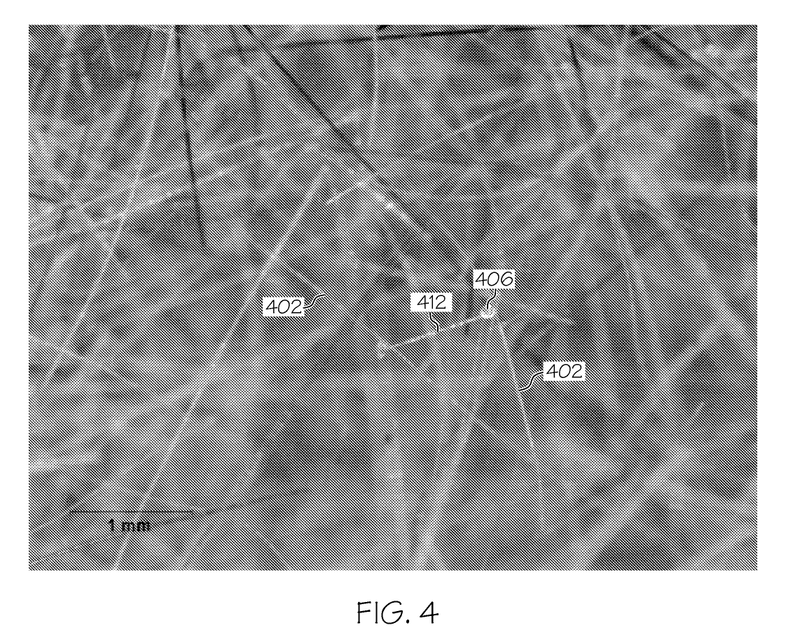

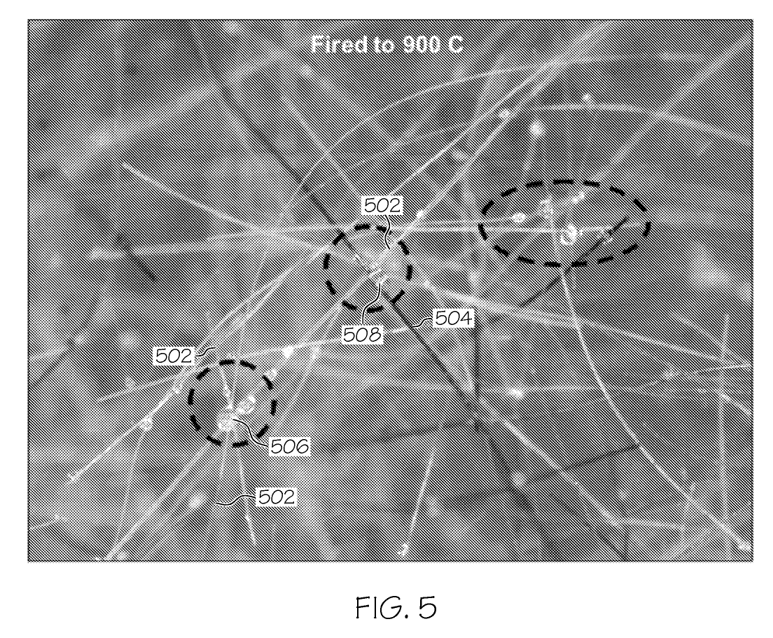

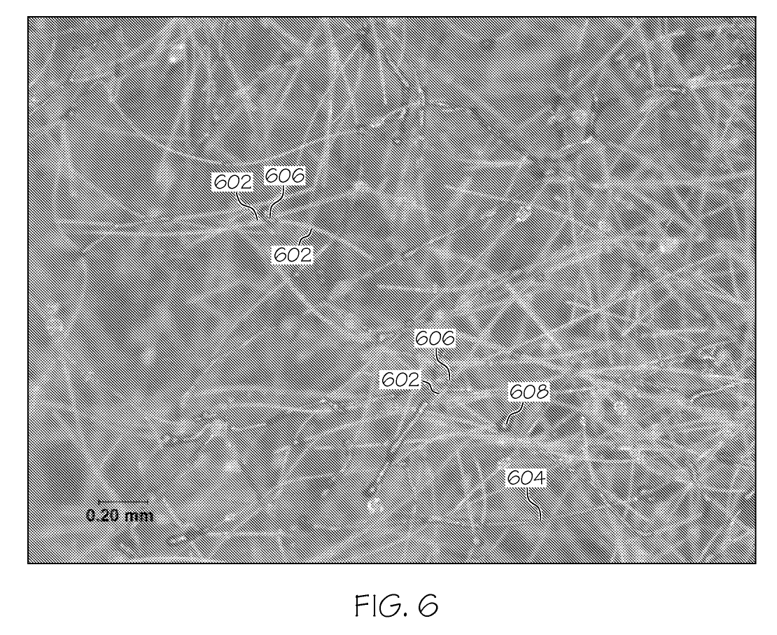

FIGS. 4-6 are micrographs of a portion of the bulk absorber manufacture according to the above-described process. In particular, FIG. 4 is the bulk absorber after being heat treated to 800° C., FIG. 5 is the bulk absorber after being heat treated to 900° C., and FIG. 6 is the bulk absorber after being heat treated to 1000° C. As shown in the micrographs, the bulk absorber included spherical balls 406, 506, 606, 508, 608 formed between fibers of the high silica fiber felt 402, 502, 602 and/or the basalt fibers 404, 504, 604. It appeared that glass fiber used as binder had melted or softened at locations that were adjacent to fibers of the high silica fiber felt to form spherical balls 406, 506, 606, or to the basalt fibers to form spherical balls 508, 608 (FIGS. 5 and 6) such that the fiber junctions are secured. The heat treatment at the lowest temperature 800° in FIG. 4 resulted in the short glass fibers forming dumbbell shaped links 412 between adjacent fibers 402.

By including glass powder as the binder for the bulk absorber, noise suppression panels capable of withstanding and operating at temperatures of at least 704° C. may be produced. By including the glass, either as a powder or as a fiber, the bulk absorber may be capable of suppressing noise even after exposure to fluids, such as fuels, hydraulic fluids, and water. Moreover, by employing the methods described above to manufacture the bulk absorber, a desired volume fraction of solids may be maintained within a loose, fluffy mass of fibers and binder during the manufacturing process. Additionally, the bulk absorbers may be resistant to degradation or oxidation when exposed to certain fluids, such as aerospace hydraulic fluid, Skydrol, or when exposed to elevated temperatures. Organic binders may give off toxic fumes upon decomposition.

While the inventive subject matter has been described with reference to a preferred embodiment, it will be understood by those skilled in the art that various changes may be made and equivalents may be substituted for elements thereof without departing from the scope of the inventive subject matter. In addition, many modifications may be made to adapt to a particular situation or material to the teachings of the inventive subject matter without departing from the essential scope thereof. Therefore, it is intended that the inventive subject matter not be limited to the particular embodiment disclosed as the best mode contemplated for carrying out this inventive subject matter, but that the inventive subject matter will include all embodiments falling within the scope of the appended claims.

We claim:

1. A method of manufacturing a bulk absorber, the method comprising the steps of:
mixing a first type of fibers and a binder together to form a material mixture, the first type of fibers comprising ceramic microfibers, and the binder comprising a glass material;
hydrating the material mixture with water vapor to form a hydrated mixture; and
heat treating the hydrated mixture to form the bulk absorber.

2. The method of claim 1, further comprising the step of:
incorporating air into the material mixture.

3. The method of claim 1, wherein the material mixture comprises fibrillated microfibers and reinforcement microfibers.

4. The method of claim 1, wherein the first type of fibers comprise basalt microfibers.

5. The method of claim 1, wherein the first type of fibers comprise aramid fibers.

6. The method of claim 1, wherein the first type of fibers is selected from a group consisting of carbon fibers, ceramic fibers, alumina, and silica.

7. The method of claim 1, wherein the binder comprises a water-soluble glass powder including sodium metasilicate.

8. The method of claim 1, wherein the step of mixing comprises mixing the first type of fibers and the binder with a second type of fibers, wherein the second type of fibers is selected from a group consisting of basalt microfibers, carbon microfibers, aramid microfibers, and glass fibers.

9. A method of forming a bulk absorber, comprising:
mixing a first type of microfiber and a binder together to form a material mixture, the first type of microfiber comprising a mineral-based material, and the binder comprising glass fibers; and
linking microfibers comprising the first type of microfiber together with the glass fibers by heat treating the material mixture at a predetermined temperature for softening the glass fibers to thereby form the bulk absorber.

10. The method of claim 9, wherein the mineral-based material comprises basalt microfibers.

11. The method of claim 9, wherein the glass fibers comprise E-glass fibers.

12. The method of claim 9, wherein the glass fibers comprise a glass fiber felt.

13. The method of claim 9, wherein the step of mixing comprises the step of:
incorporating air into the material mixture.

14. The method of claim 9, wherein the step of linking comprises the step of:
heating the material mixture to a temperature between a softening point temperature of the glass fibers and 100° C. below the softening point temperature of the glass fibers.

15. The method of claim 9, wherein the step of linking comprises the step of:
heating the material mixture to a temperature between a softening point temperature of the glass fibers and 60° C. below the softening point temperature of the glass fibers.

16. A method of manufacturing a noise suppression panel, the method comprising the steps of:
mixing a first type of fibers and a binder together to form a material mixture, the first type of fibers comprising a ceramic material, and the binder comprising a water-soluble glass powder;
hydrating the material mixture with water droplets to form a hydrated mixture;
heat treating the hydrated mixture to form a bulk absorber; and
placing the bulk absorber between a face plate and a backing plate to form the noise suppression panel.

17. The method of claim 16, wherein the step of forming the bulk absorber further comprises the step of:
supplying air to the material mixture.

18. The method of claim 16, wherein the material mixture comprises fibrillated microfibers and reinforcement microfibers.

19. The method of claim 16, wherein the first type of fibers comprise basalt microfibers.

20. The method of claim 16, wherein the water-soluble glass powder comprises sodium metasilicate.
